(19) United States
(12) Patent Application Publication
(10) Pub. No.: US 2020/0221741 A1
(43) Pub. Date: Jul. 16, 2020

(54) FOOD PRODUCTS WITH REDUCED RAG:SAG RATIO

(71) Applicant: The Quaker Oats Company, Chicago, IL (US)

(72) Inventors: Simarata DHILLON, Frisco, TX (US); Jodee JOHNSON, Lake in the Hills, IL (US); John SCHUETTE, Woodstock, IL (US); Saravanan SUPPIAH SINGARAM, Streamwood, IL (US); Congqi YAN, Schaumburg, IL (US)

(21) Appl. No.: 16/246,043

(22) Filed: Jan. 11, 2019

(51) Int. Cl. A23L 7/126; A23L 7/10

(52) U.S. Cl. CPC A23L 7/126; A23L 7/1975; A23V 2200/328; A23V 2200/21; A23V 2002/00

(57) ABSTRACT

A novel granola-based product with reduced RAG: SAG ratio and a corresponding method of manufacture are described herein. The granola-based food product includes a binder and dry mix that includes low-RAG oat flakes. Additionally, the granola-based food product has a RAG: SAG ratio of less than or equal to 6.

### BACKGROUND

### Technical Field

Novel aspects of the present disclosure relate to a granola-based food product and a corresponding method of manufacture. More particularly, the present disclosure is directed to a novel granola-based food product having a reduced RAG: SAG ratio.

### Background

Dietary carbohydrates are digested and absorbed at different rates upon consumption. Carbohydrates that are quickly absorbed are referred to as rapidly available glucose (RAG), and carbohydrates that are slowly absorbed are referred to as slowly available glucose (SAG). The Englyst assay, which is an in-vitro method for classifying digestible carbohydrates according to rate of digestion, involves coarsely grinding up a food sample to simulate mastication and subjected to an enzymatic digestion process under standardized conditions to mimic traditional digestion. Glucose available at 20 minutes of simulated digestion is identified as RAG. At 120 minutes, available glucose is measured, then the RAG levels at 20 minutes are subtracted. The remainder is the SAG concentration that is available between 20 and 120 minutes. Thus, the Englyst method classifies available carbohydrates into two groups: RAG and SAG. Relative amounts of RAG and SAG in a food product can be qualified in terms of a RAG:SAG ratio in which higher values are associated with food products having more rapidly available carbohydrates and lower values are associated with food products having more slowly available carbohydrates. Accordingly, the Englyst assay has been correlated with the human blood glucose response.

### SUMMARY OF THE INVENTION

Consumer preferences dictate much of the innovation for food-based products. For example, some consumers have shown a preference for snacks that can be eaten on the go. Another emerging trend is a preference for food products that consumers deem to be healthier, particularly those that are formed from granola. Existing scientific literature suggests that food products higher in slowly digestible carbohydrates provide a reduction in postprandial glycemic response compared to food products low in slowly digestible carbohydrates. Therefore, novel aspects of the disclosure are directed to a granola-based food product that can be eaten on the go and which has a low RAG: SAG ratio.

In one embodiment, novel aspects of the present invention are directed to a granola-based food product formed from a binder and dry mix that includes at least low-RAG oat flakes. In addition, the granola-based food product has a RAG: SAG ratio of 6 or less.

In another embodiment, novel aspects of the present invention are directed to a method of manufacturing a granola-based food product. The method includes the steps of combining a dry mix, which includes low-RAG oat flakes, with a binder to form a granola mixture having a moisture content between 7-21 wt %. Thereafter, the granola mixture is cooked in a multi-zone oven that provides at least a partially increasing temperature gradient to form the granola-based food product with a RAG: SAG ratio of 6 or less.

In yet another embodiment, novel aspects of the present invention are directed to a method of forming a low-RAG oat flake. The method includes the steps of steaming the cut oat groats at an oat steaming temperature between 170-190° F. to form steamed oat groats, then flaking the steamed oat groats to form the low-RAG oat flakes. In a non-limiting embodiment, the low-RAG oat flakes have a thickness between 0.022-0.016 inches.

Other aspects, embodiments and features of the invention will become apparent from the following detailed description of the invention when considered in conjunction with the accompanying figures. In the figures, each identical, or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention.

### BRIEF DESCRIPTION OF THE FIGURES

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying figures, wherein:

FIG. 1 is a chart illustrating the general effect of flake thickness on RAG:SAG ratio of a starch-containing ingredient.

FIG. 2 is a chart illustrating the general effect of processing on RAG: SAG ratio of a starch-containing ingredient.

FIG. 3 is a high-level flowchart of a process for forming a granola-based food product in accordance with an illustrative embodiment

FIG. 4 is a flowchart of a process for forming a low-RAG oat flake in accordance with an illustrative embodiment

FIG. 5 is a flowchart of a process for forming wheat flakes in accordance with an illustrative embodiment.

FIG. 6 is a flowchart of a process for cooking a granola mixture in accordance with an illustrative embodiment.

### DETAILED DESCRIPTION

Oats and oat-based food products have recently experienced a resurgence in popularity as a result of the increasing number of studies documenting health benefits derived from consuming oats, such as the promotion of healthy heart function. For example, the high soluble fiber content of oats, mainly in the form of β-glucan, provides oats the ability to reduce low-density lipoprotein (LDL) cholesterol levels by increasing the conversion of cholesterol to bile. Additionally, consumption of oats has been shown to prevent the development of atherosclerosis through inhibition of oxidative stress and inflammation. Other known benefits of oat consumption include anti-proliferative, vasodilation, and anti-itch effects.

Granola is an oat-based food product that is generally formed from a dry mix held together by a binder. Granola can be consumed as-is or integrated into popular food products, such as cereal or granola bars. Depending upon the particular formulation of the granola and the various processing steps utilized, the RAG: SAG ratio of the granola can be undesirably high. Novel aspects of present disclosure are directed to a granola-based food product with a target RAG:SAG ratio that can be achieved by careful ingredient selection and novel processing techniques.

Food products with a reduced RAG: SAG ratio may contribute to a reduction of the postprandial glycemic response after a meal. For these reasons, recent research efforts have been directed to the manufacture of food products characterized by a low RAG: SAG ratio. Ingredient selection has a direct effect on the RAG: SAG ratio of a food product because the ingredients are the source of RAG and SAG that are used to determine the RAG: SAG ratio of the final product. Additionally, the processing of ingredients that are ultimately incorporated into granola-based food products also affects the RAG: SAG ratio of the final product. For example, many ingredients incorporated into granola-based food products are processed at high temperatures with a high moisture content or in a high moisture environment, which promotes gelatinization of its starchy ingredients. Gelatinization is the swelling and loss of crystalline order of starch granules in the presence of heat and moisture, which results in the expulsion of polysaccharides from the starch granules. The exposed polysaccharides are more readily digestible, which is manifested as RAG. Thus, reducing gelatinization can reduce the presence of RAG and increase the presence of SAG. The effect of ingredient selection and processing will be discussed in more detail in the paragraphs that follow.

Ingredient Selection

To understand the effect of ingredient selection on the final RAG: SAG ratio, it is helpful to understand that RAG is a defined entity of starch with subtypes but that SAG is less well-defined in that there are no definitive subtypes, and its existence is qualified based upon a manifestation of glucose between 20-120 minutes after enzyme digestion. Thus, an ingredient that is described as having an amount of SAG is understood as having an amount of absorbable carbohydrate manifested at a time between 20-120 minutes. RAG:SAG ratio can be decreased by using an ingredient with a higher amount of SAG, eliminating an ingredient with a low amount of SAG, or by substituting high-RAG ingredients with low-RAG ingredients.

To illustrate the foregoing concepts, the consumption of pure glucose will typically be manifested as RAG (with a rise in blood glucose levels at 20 minutes of consumption) and result in the rapid blood glucose spike. Eliminating the glucose ingredient would reduce the RAG: SAG ratio, or replacing the ingredient with a glucose substitute could have the same effect. With reference to a granola-based food product that includes starch-containing ingredients, the exclusion of ingredients with higher amounts of RAG, such as cooked corn flakes and crisped, puffed rice, would also result in a granola-based food product with a lower RAG: SAG ratio. Similarly, because ungelatinized wheat-based ingredients have starches that are less rapidly digested than oat-based ingredients in the Englyst assay, replacing at least a portion of the oat-based ingredient with wheat-based ingredients would also help form a product with a reduced RAG: SAG ratio.

In some embodiments, the use of low-RAG grain flakes instead of conventional grain flakes can reduce the RAG: SAG ratio of a granola-based food product. The RAG: SAG ratio of these low-RAG grain flakes, examples of which include low-RAG oat flakes, can be attributable to their physical characteristics and/or a series of novel processing steps to create a grain flake that has a RAG: SAG ratio that is lower than their conventional counterparts. For example, thicker flakes have starch granules that are better protected from exposure to moisture and heat, which reduces gelatinization. A-grade flakes generally have a thickness of 0.025 inches, whereas B-grade flakes have a thickness of about 0.018 inches and tests have shown that the RAG: SAG ratio of A-grade flakes are lower than the RAG: SAG ratio of B-grade flakes. For the purposes of this discussion, it is helpful to know that A-grade oats are formed from whole A-grade groats that are first steamed then flaked to a desired thickness. B-grade oats are formed from B-grade groats that are first cut into thirds, steamed, and then flaked. Thus, B-grade oats are generally smaller and thinner than A-grade oats.

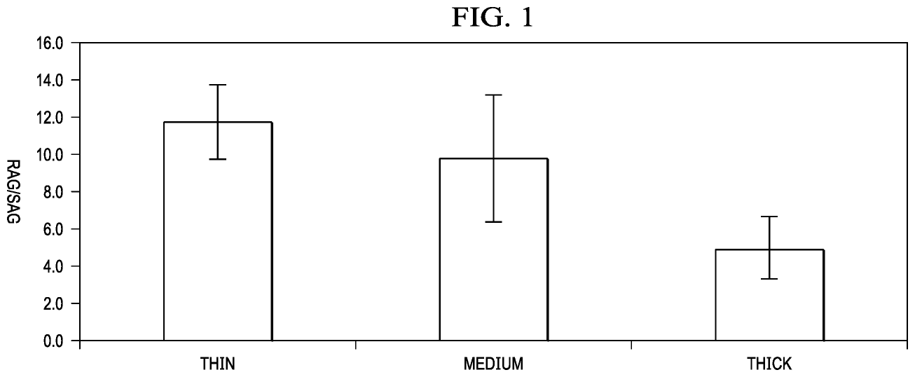

To illustrate the effect of flake thickness on RAG: SAG ratio, B-grade oats were flaked to various thicknesses and incorporated into a granola-based food product, and the resultant RAG: SAG ratio of the final food product was determined. The results are shown in FIG. 1, FIG. 1 shows that increasing thickness of the oat flake corresponded with decreasing RAG: SAG ratio. From these results, inventors were able to conclude that the RAG: SAG ratio of B-grade oats can be reduced by controlling flake thickness. Thus, the thickness of an oat flake can be controlled to create low-RAG grain flakes, such as low-RAG oat flakes. The RAG: SAG ratio of low-RAG oat flakes described herein is also attributable to specific processing steps, as described in more detail in the discussion of FIG. 4, which also helps to reduce starch gelatinization.

Some existing formulations for granola-based food products use B-grade oats. Replacing B-grade oats with A-grade oats can create a granola-based food product with a lower RAG:SAG ratio. However, such a substitution would require product design changes and would result in a food product with visual and organoleptic characteristics that differ from what consumers have come to expect. Thus, at least in some embodiments where B-grade oats are specifically called for, A-grade oats cannot be substituted to achieve lower RAG: SAG ratios. Instead, replacing conventional grain flakes with their low-RAG counterparts (e.g., B-grade oat flakes with low-RAG, B-grade oat flakes) can reduce their respective RAG: SAG ratios, which in turn reduces the RAG: SAG ratio of the resultant granola-based food product without requiring product design changes and while also preserving the excepted visual and organoleptic characteristics.

As used herein, a low-RAG oat flake is an oat flake that has a RAG: SAG ratio that is at least 35-65% less than the RAG: SAG ratio of conventional oat flakes, or more particularly with a RAG: SAG ratio that is about 58% less than the RAG: SAG ratio of conventional oat flakes. In one embodiment, the low-RAG oat flakes are B-grade oat flakes that have an average thickness between 0.020 to 0.030 inches, or more particularly the average thickness of the low-RAG oat flakes is between 0.0225 to 0.0275 inches. In a particular embodiment, the average thickness of the low-RAG oat flake is about 0.025 inches. In another embodiment, where thinner oat flakes are required, low-RAG oat flakes can be flaked to an average thickness between 0.022-0.16 inches, or more particularly to an average thickness between 0.0205-0.175 inches. In a particular embodiment, the average thickness of the low-RAG oat flake is about 0.019 inches.

In other embodiments, particularly when not constrained by ingredient selection and/or any expectation as to the visual or organoleptic properties of the final product, the resultant granola-based product disclosed herein can include ingredients specially selected to provide new granola-based food products with a target RAG: SAG ratio. For example, the formulation of a granola-based product formed in accordance with the present disclosure can exclude ingredients with fully-gelatinized starch, or exclude ingredients with a significant amount of gelatinized starch, such as cooked corn flakes or puffed, crisp rice. In addition, ingredients can be selected and their relative amounts varied to achieve the target RAG: SAG ratio. For example, B-grade oats can be replaced with A-grade oats. Because the starch in wheat-based ingredients are less digestible than oat-based ingredients, increasing amounts of wheat flakes with a concomitant decreasing amounts of oat flakes or low-RAG oat flakes can also result in a granola-based food product with an even lower RAG: SAG ratio. Thus, in one embodiment, a granola-based food product formed in accordance with the novel aspects disclosed herein can include a ratio of low-RAG oat flakes to wheat flakes that is about 1:2. In other embodiments, the ratio of low-RAG oat flakes to wheat flakes can range between 1:2 to 2:1, and in a particular embodiment, the ratio of the low-RAG oat flakes to wheat flakes is about 1:1.

In another non-limiting embodiment, the low-RAG oat flakes and the wheat flakes comprise between 54-74 wt % of the granola-based food product, and in a more particular embodiment, the low-RAG oat flakes and the wheat flakes comprise between 59-69 wt % of the granola-based food product. In an exemplary embodiment, the granola-based food product includes low-RAG oat flakes and the wheat flakes that comprise about 64 wt % of the granola-based food product.

In another exemplary embodiment, the granola-based food product includes low-RAG oat flakes present in an amount between 22-42 wt % of the granola-based food product, and in a more particular embodiment, the low-RAG oat flakes are present in amount between 27-37 wt % of the granola-based food product. In a specific embodiment, the low-RAG oat flakes are present in an amount of about 32 wt % of the granola-based food product. In this exemplary embodiment or in another embodiment, the wheat flakes are present in an amount between 22-42 wt % of the granola-based food product, or more particularly the wheat flakes are present in an amount between 27-37 wt % of the granola-based food product. In a more specific embodiment, the wheat flakes are present in an amount of about 32 wt % of the granola-based food product.

The low-RAG oat flakes and the wheat flakes previously described are included in the general category of ingredients referred to in the collective as “dry mix.” Dry mix can also include a premix formed from nonfat dry milk, whey powder, whey protein concentrate, and sunflower oil. The dry mix can constitute between 65-75 wt % of the granola-based food product, or between 68-72 wt % of the granola-based food product. In a particular embodiment, the dry mix can constitute about 70.6 wt % of the granola-based food product.

The dry mix is held together by a binder that can include brown sugar, honey, inulin, water, coconut flavor, canola oil, or combinations thereof. In a non-limiting embodiment, the binder forms between 25-35 wt % of the granola-based food product, and in a more particular embodiment, the binder comprises between 28-32 wt % of the granola-based food product. In an exemplary embodiment, the binder comprises about 29.4 wt % of the granola-based food product. In accordance with the foregoing, an exemplary formulation of the granola-based food product formed from oat flakes and wheat flakes is shown in Table 1.

TABLE 1
Exemplary Formulation of a Granola-Based Food Product.

| | AMOUNT (wt %) |
|---|---|
| DRY MIX (70.6 wt %) | |
| Oat Flakes | 32.04 |
| Wheat Flakes | 32.04 |
| Nonfat Dry Milk | 2.03 |
| Whey Powder | 3.04 |
| Whey Protein Concentrate | 1.30 |
| Sunflower Oil | 0.13 |
| BINDER INGREDIENTS (29.4 wt %) | |
| Brown Sugar | 13.98 |
| Honey | 0.26 |
| Inulin | 2.93 |
| Water | 6.08 |
| Canola Oil | 5.98 |
| Coconut Flavor | 0.20 |

To achieve a granola-based food product with a lower RAG:SAG ratio, the oat flakes shown in Table 1 can be replaced by low-RAG oat flakes. For example, when using oat flakes formed by conventional processes, and when the granola mixture is cooked according to conventional temperature profiles, the RAG: SAG ratio of the granola-based food product having the ingredients depicted in Table 1 is as high as 7. However, when low-RAG oat flakes are used instead, and when the granola mixture is cooked according to the novel temperature profile discussed in FIG. 6, the resultant RAG: SAG ratio is 6 or less, and in a specific embodiment the RAG: SAG ratio is about 4.3.

Ingredient Processing

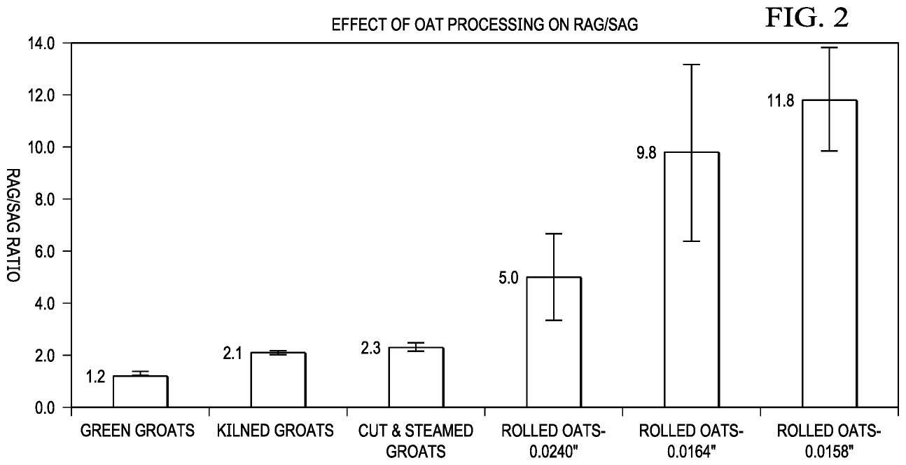

To illustrate the effect of processing on the RAG:SAG ratio of a grain-based ingredient, and thus on the final RAG: SAG ratio of the final granola-based food product, the RAG: SAG ratio of an oat ingredient was determined after various stages of processing. In particular, inventors processed green groats, which are unprocessed oats, into oat flakes while periodically measuring RAG: SAG ratios. The processing steps include dehulling the green groats, then kilning the green groats in an environment maintained at a predetermined temperature and moisture to form kilned groats. Kilning stabilizes the oat groats to terminate any enzymatic activity that could cause rancidity. To form B-grade oat flakes, the kilned groats are then cut approximately into thirds. The cut groats are steamed, then flaked to one of three thicknesses to form oat flakes. The RAG: SAG ratio was determined at each of these various stages throughout the processing of the oat ingredient and depicted in FIG. 2. As can be seen, the green groats are unprocessed and have the lowest RAG: SAG ratio of 1.2. As the oats are subjected to further processing, the RAG: SAG ratio increases. The oat flakes have higher RAG: SAG ratios than the green groats, the kilned groats, and the cut/steamed groats. In addition, decreasing thickness of the oat flakes show increasingly higher RAG: SAG ratios.

Further experiments were conducted on the processing of the oat ingredients to determine factors that have the most significant impact on RAG: SAG ratio. The results, which are depicted in Table 2 below, confirm that additional processing causes a shift to greater amounts of RAG and lesser amounts of SAG as determined by the Englyst assay, which can be due to greater gelatinization and/or more extensive starch granule damage.

TABLE 2
Effect of Steam and Flake Thickness on RAG:SAG Ratio on Oats.
Effect of Steam Temperature on RAG:SAG Ratio for
Oat Groats (Steam Time = 7 minutes)

| Steam Temperature (° F.) | RAG:SAG Ratio |
|---|---|
| 150 | 2.28 |
| 180 | 2.2 |
| 215 | 2.14 |

Effect of Steam Time on RAG:SAG Ratio for
Oat Groats (Steam Temperature = 212° F.)

| Steam Time (Minutes) | RAG:SAG Ratio |
|---|---|
| 0 | 2.3 |
| 7 | 2.14 |
| 15 | 2.35 |

Effect of Flake Thickness on RAG:SAG Ratio for
Oat Flakes (Steam Temperature = 212° F.
and Steam Time = 7 minutes)

| Flake Thickness (inches) | RAG:SAG Ratio |
|---|---|
| 0.0158 | 11.76 |
| 0.0164 | 9.23 |
| 0.024 | 4.77 |

Similar experiments were conducted on the wheat ingredient, and the results showed that wheat-based starch was more resistant to starch gelatinization when compared to the oat ingredient. In fact, the RAG: SAG ratio of wheat flakes was not significantly different when steaming temperature was varied between 150-215° F., steaming time was varied between 0-15 minutes, and wheat flake thickness was varied. Thus, processing has an effect on the amount of starch gelatinization, which effects the RAG: SAG ratio of certain starch-containing ingredients, namely oat flakes. Reduction of starch gelatinization is achieved by an improved flaking process that controls grain flake size, moisture content, and flaking temperature, and by an improved cooking process that utilizes a multi-zone oven providing an at least partially increasing temperature profile that has been shown to result in a decreased RAG: SAG ratio in granola-based food products. In one embodiment, the RAG: SAG ratio of the granola-based food product is less than about 6, and in a more specific embodiment the RAG: SAG ratio of the granola-based food product is less than about 5.2. More specifically, the RAG: SAG ratio of the granola-based food product is at least between 3.56-5.2, but more preferably between 3.97-4.79. In a particular embodiment, the RAG: SAG ratio is about 4.38. In this or another embodiment, the granola-based food product has a moisture content between 1.5-3.0 wt %, or more particularly the granola-based food product further comprises a moisture content between 2.0-2.5 wt %. In a non-limiting embodiment, the granola-based food product further comprises a moisture content of about 2.1 wt %.

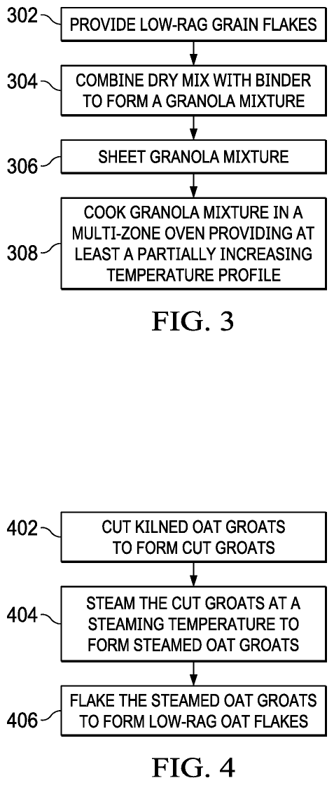

FIG. 3 is a high-level flowchart of a process for forming a granola-based food product in accordance with an illustrative embodiment. In a first step, low-RAG grain flakes are provided (Step 302). In a non-limiting embodiment, the low-RAG grain flake can be a low-RAG oat flake, and in a more particular embodiment, the low-RAG oat flake is a B-grade oat flake formed according to the process depicted in FIG. 4. Next, a dry mix is combined with a binder to form a granola mixture with a moisture content between 9-21 wt %, or more particularly between 10-18 wt %, and in a particular embodiment the dry mix and binder form a granola mixture with a moisture content between 12-16 wt % (Step 304). In a non-limiting embodiment, the dry mix includes low-RAG oat flakes and wheat flakes, and a premix formed from nonfat dry milk, whey powder, whey protein concentrate, and sunflower oil. In addition, the binder can include one or more ingredients selected from sugar, honey, water, inulin, coconut flavor, or canola oil. In one embodiment, the dry mix is combined with the binder in a batch process conducted at room temperature and mixed with conventionally available equipment, such as a rotating drum. The binder is mixed at an elevated temperature between 155-180° F., or more specifically at a temperature between 160-175° F. In a particular embodiment, the binder is mixed at an elevated temperature of about 165° F., and then combined with the dry mix while the binder is at the elevated temperature to facilitate mixing.

The granola mixture is then sheeted (Step 306). The granola mixture can be sheeted to a thickness between 1-2.5 inches, or more particularly to a thickness between a 1.25-2.25 inches. In a particular embodiment, the granola mixture is sheeted to a thickness between about 1.5-2 inches. Further, the granola mixture can be sheeted onto a baking pan in a batch-type process, each baking pan conveyed through a multi-zone oven for subsequent cooking. In another embodiment, the granola mixture can be continually sheeted onto an endless conveyor that conveys the sheeted granola mixture through the multi-zone oven for cooking. In still further embodiments, rather than sheeting the granola mixture, the granola mixture can be molded into other shapes, such as spheres to form clusters.

The granola mixture is cooked in a multi-zone oven that provides at least a partially increasing temperature gradient to form the granola-based food product with a RAG:SAG ratio of 6.0 or less (Step 308). In a non-limiting embodiment, the partially increasing temperature gradient is provided at the upstream end of the multi-zone oven so that the granola mixture is exposed to relatively lower heat at the start of the cooking process when the moisture content of the granola mixture is the highest. As the moisture content is reduced, increasing cooking temperatures have a smaller impact on the RAG: SAG ratio of the final granola-based food product because of the decreased moisture content.

FIG. 4 is a flowchart of a process for providing a low-RAG oat flake in accordance with an illustrative embodiment. In a first step, kilned, B-grade oat groats are cut to form cut oat groats (Step 402). In one embodiment, the kilned oat groats are cut approximately into thirds.

The cut oat groats are then steamed at an oat steaming temperature between 165-195° F. to form a steamed oat groat (Step 404). The oat steaming temperature can be in the range between 175-185° F., and in a non-limiting embodiment, the oat steaming temperature is about 180° F.

Thereafter, the steamed oat groats are flaked to form the low-RAG oat flakes (Step 406). The steamed oat flakes can be flaked to an average thickness between 0.022-0.016 inches, or more particularly to an average thickness between 0.0205-0.0175 inches. In this or another embodiment, the steamed oat groats are flaked to an average thickness of about 0.019 inches.

To the extent that a kilned, B-grade oat groat is not initially provided, B-grade groats can be kilned at a kilning temperature to form a kilned oat groat. The kilning temperature can be in a range between 175-245° F., or more specifically between 185-235° F. In a non-limiting embodiment, the kilning temperature is between 195-225° F. In addition, the oat groat is kilned for a length of time that is known in the art. Thereafter, the kilned oats are processed according to the method of FIG. 4, starting at Step 402.

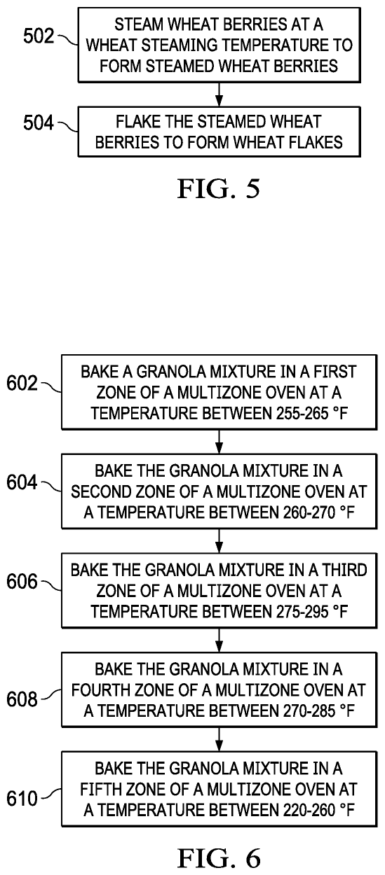

FIG. 5 is a flowchart of a process for forming wheat flakes in accordance with an illustrative embodiment. In a first step wheat berries are steamed at a temperature between 180-220° F. to form steamed wheat berries (Step 502). In another embodiment, the wheat berries can be steamed at a temperature between 190-210° F., or more specifically at a temperature of about 200° F. Thereafter, the wheat berries are flaked to form the wheat flakes (Step 504).

In one embodiment, the wheat berry is flaked to an average thickness between 0.0390-0.0217 inches, or more particularly the wheat berry is flaked to an average thickness between 0.0373-0.0230 inches. In a particular embodiment, the wheat berry is flaked to an average thickness of about 0.0339 inches, 0.0294 inches, 0.0255 inches, or combinations thereof.

FIG. 6 is a flowchart of a process for cooking a granola mixture in accordance with an illustrative embodiment. The process may be implemented in step 308 in the flowchart shown in FIG. 3. A granola mixture is baked in a first zone of a multi-zone oven which is maintained at a first temperature between 255-265° F. (Step 602). In a more specific embodiment, the first temperature in the first zone is between 258-262° F., and in a non-limiting embodiment, the first temperature in the first zone is about 260° F. Additionally, the granola mixture is baked in the first zone for a first baking time between 3-10 minutes, or more particularly for a first baking time between 4-6 minutes. In a non-limiting embodiment, the first baking time is about 5 minutes.

The granola mixture is then baked in a second zone of the multi-zone oven which is located downstream from the first zone and maintained at a second temperature between 260-270° F. that is higher than the first temperature (Step 604). In a more specific embodiment, the second temperature in the second zone is between 263-267° F., and in a non-limiting embodiment, the second temperature in the second zone is about 265° F. Additionally, the granola mixture is baked in the second zone for a second baking time between 3-10 minutes, or more particularly for a second baking time between 4-6 minutes. In a non-limiting embodiment, the second baking time is about 5 minutes.

In some embodiments, the granola mixture can be subjected to further cooking steps that occur in one or more downstream zones. For example, the granola mixture can be baked in a third zone of the multi-zone oven which is located downstream from the second zone and maintained at a third temperature between 275-295° F. that is higher than the second temperature (Step 606). In a more specific embodiment, the third temperature in the third zone is between 280-290° F., and in a non-limiting embodiment, the third temperature is about 285° F. Additionally, the granola mixture is baked in the third zone for a third baking time between 3-10 minutes, or more particularly for a third baking time between 4-6 minutes. In a non-limiting embodiment, the third baking time is about 5 minutes.

The granola mixture can be conveyed to a fourth zone of the multi-zone oven which is located downstream from the third zone and maintained at a fourth temperature between 270-285° F. that is lower than the third temperature (Step 608). In a more specific embodiment, the fourth temperature in the fourth zone is between 275-282° F., and in a non-limiting embodiment, the fourth temperature is about 280° F. Additionally, the granola mixture is baked in the fourth zone for a fourth baking time between 3-10 minutes, or more particularly for a fourth baking time between 4-6 minutes. In a non-limiting embodiment, the fourth baking time is about 5 minutes.

The granola mixture can also be conveyed to a fifth zone of the multi-zone oven which is located downstream from the fourth zone and maintained at a fifth temperature between 220-260° F. that is lower than the fourth temperature (Step 610). In a more specific embodiment, the fifth temperature in the fifth zone is between 230-250° F., and in a non-limiting embodiment, the fifth temperature is about 240° F. Additionally, the granola mixture is baked in the fifth zone for a fifth baking time between 3-10 minutes, or more particularly for a fifth baking time between 4-6 minutes. In a non-limiting embodiment, the fifth baking time is about 5 minutes.

The novel processing steps, namely the flaking process and the cooking process, can be used to create granola-based food products having reduced RAG: SAG ratio when compared to conventionally available granola-based food products. When not constrained by ingredient selection, the additional variable of ingredient selection can further reduce the RAG: SAG ratio of granola-based food products.

### ADDITIONAL EMBODIMENTS

The following descriptive embodiments are offered in further support of the disclosed invention.

In a first embodiment, novel aspects of the present disclosure are directed to a granola-based food product comprising: a binder; and dry mix, wherein the dry mix further comprises low-RAG oat flakes; and wherein a RAG: SAG ratio of the granola-based food product is 6.0 or less.

In another aspect of the first embodiment the granola-based food product comprises: a binder; and dry mix, wherein the dry mix further comprises low-RAG oat flakes; and wherein a RAG: SAG ratio of the granola-based food product is 6.0 or less; and wherein the granola-based food product comprises one or more limitations selected from the following:

wherein the dry mix further comprises wheat flakes;

wherein the low-RAG oat flakes have an average thickness between 0.020 to 0.030 inches;

wherein the low-RAG oat flakes have an average thickness between 0.0225 to 0.0275 inches;

wherein the low-RAG oat flakes have an average thickness of about 0.025 inches;

wherein the low-RAG oat flakes have an average thickness between 0.022-0.016 inches;

wherein the low-RAG oat flakes have an average thickness between 0.0205-0.0175 inches;

wherein the low-RAG oat flakes have an average thickness of about 0.019 inches;

wherein the low-RAG oat flakes is present in an amount between 22-42 wt % of the granola-based food product;

wherein the low-RAG oat flakes is present in an amount between 27-37 wt % of the granola-based food product;

wherein the low-RAG oat flakes is present in an amount of about 32 wt % of the granola-based food product;

wherein the wheat flakes are present in an amount between 22-42 wt % of the granola-based food product;

wherein the wheat flakes are present in an amount between 27-37 wt % of the granola-based food product;

wherein the wheat flakes are present in an amount of about 32 wt % of the granola-based food product;

wherein a ratio of the low-RAG oat flakes to wheat flakes is between 1:2 to 2:1;

wherein the ratio of the low-RAG oat flakes to wheat flakes is about 1:1;

wherein the low-RAG oat flakes and the wheat flakes comprise between 54-74 wt % of the granola-based food product;

wherein the low-RAG oat flakes and the wheat flakes comprise between 59-69 wt % of the granola-based food product;

wherein the low-RAG oat flakes and the wheat flakes comprise about 64 wt % of the granola-based food product;

wherein the dry mix comprises between 65-75 wt % of the granola-based food product;

wherein the dry mix comprises between 68-72 wt % of the granola-based food product;

wherein the dry mix comprises between 70 wt % of the granola-based food product;

wherein the binder comprises between 25-35 wt % of the granola-based food product;

wherein the binder comprises between 28-32 wt % of the granola-based food product;

wherein the binder comprises about 29.4 wt % of the granola-based food product;

wherein the binder comprises at least one of brown sugar, honey, inulin, water, coconut flavor, canola oil, or combinations thereof;

wherein the dry mix further comprises at least one of nonfat dry milk, whey powder, whey protein concentrate, sunflower oil, or combinations thereof;

wherein the granola-based food product further comprises a RAG:SAG ratio less than 5.2;

wherein the granola-based food product further comprises a RAG:SAG ratio between 3.56-5.2;

wherein the granola-based food product further comprises a RAG:SAG ratio between 3.97-4.79;

wherein the granola-based food product further comprises a RAG:SAG ratio of about 4.38;

wherein the granola-based food product further comprises a moisture content between 1.5-3.0 wt %;

wherein the granola-based food product further comprises a moisture content between 2.0-2.5 wt %;

wherein the granola-based food product further comprises a moisture content of about 2.1 wt %;

In a second embodiment, novel aspects of the present disclosure are directed to a method for forming a granola-based food product with a target RAG: SAG ratio, the method comprising: combining dry mix with a binder to form a granola mixture, wherein the dry mix comprises low-RAG oat flakes, and wherein the granola mixture has a moisture content between 7-21 wt %; cooking the granola mixture in a multi-zone oven, wherein the multi-zone oven provides at least a partially increasing temperature gradient to form the granola-based food product with the target RAG: SAG ratio of less than 6.

In another aspect of the second embodiment, novel aspects of the present disclosure are directed to a method for forming a granola-based food product having a target RAG: SAG ratio, the method comprising: mixing dry mix with a binder to form a granola mixture, wherein the dry mix comprise low-RAG oat flakes, and wherein the granola mixture has a moisture content between 7-21 wt %; cooking the granola mixture in a multi-zone oven to a RAG: SAG ratio of less than 6, wherein the multi-zone oven provides at least a partially increasing temperature gradient to form the granola-based food product with the target RAG: SAG ratio of less than 6 and one or more limitations selected from the following:

wherein the method further comprises: providing a low-RAG oat flake;

wherein the step of providing the low-RAG oat flakes further comprises: steaming the kilned oat groat ingredient at an oat steaming temperature between 170-190° F. to form steamed oat groats; and flaking the steamed oat groats to form the low-RAG oat flakes;

wherein the oat steaming temperature is between 175-185° F. to form the steamed oat groats;

wherein the oat steaming temperature is about 180° F.;

wherein the steamed oat groats are flaked to an average thickness between 0.020-0.030 inches;

wherein the steamed oat groats are flaked to an average thickness between 0.0225 to 0.0275 inches;

wherein the steamed oat groats are flaked to an average thickness of about 0.025 inches;

wherein the steamed oat groats are flaked to an average thickness between 0.022-0.016;

wherein the steamed oat groats are flaked to an average thickness between 0.0205-0.0175;

wherein the steamed oat groats are flaked to an average thickness of about 0.019;

wherein the kilning temperature is between 175-245° F.;

wherein the kilning temperature is between 185-235° F.;

wherein the kilning temperature is between 195-225° F.;

wherein the step of providing the wheat flake further comprises: steaming a wheat berry ingredient at a wheat steaming temperature between 190-210° F.; and flaking the wheat berry ingredient to form the wheat flakes;

wherein the wheat steaming temperature is between 195-205° F.;

wherein the wheat steaming temperature is about 200° F.;

wherein the wheat berry ingredient is flaked to an average thickness between 0.0390-0.0217 inches;

wherein the wheat berry ingredient is flaked to an average thickness between 0.0373-0.0230 inches;

wherein the wheat berry ingredient is flaked to an average thickness of about 0.0339 inches;

wherein the wheat berry ingredient is flaked to an average thickness of about 0.0294 inches;

wherein the wheat berry ingredient is flaked to an average thickness of about 0.0255 inches;

wherein cooking the granola mixture further comprises: baking the granola mixture in a first zone of the multi-zone oven, wherein the first zone is maintained at a first temperature between 255-265° F.; and baking the granola mixture in a second zone of the multi-zone oven, wherein the second zone is downstream from the first zone, and wherein the second zone is maintained at a second temperature between 260-270° F. that is higher than the first temperature;

wherein the first temperature of the first zone is between 258-262° F.;

wherein the first temperature of the first zone is about 260° F.

wherein the second temperature of the second zone is between 263-267 ° F.;

wherein the second temperature of the second zone is about 265° F.;

wherein cooking the granola mixture further comprises: baking the granola mixture in a third zone of the multi-zone oven, wherein the third zone is downstream from the second zone, and wherein the third zone is maintained at a third temperature that is higher than the second temperature;

wherein cooking the granola mixture further comprises baking the granola mixture in a fourth zone of the multi-zone oven, wherein the fourth zone is downstream from the third zone, and wherein the fourth zone is maintained at a fourth temperature that is lower than the third temperature;

wherein the third temperature of the third zone is between 275-295° F.;

wherein the third temperature of the third zone is between 280-290° F.;

wherein the third temperature of the third zone is about 285° F.;

wherein the fourth temperature of the fourth zone is between 270-285° F.;

wherein the fourth temperature of the fourth zone is between 275-282° F.;

wherein the fourth temperature of the fourth zone is about 280° F.;

wherein cooking the granola mixture further comprises: baking the granola mixture in a fifth zone of the multi-zone oven, wherein the fifth zone is downstream from the fourth zone, and wherein the fifth zone is maintained at a fifth temperature that is lower than the fourth temperature;

wherein the fifth temperature of the fifth zone is between 220-260° F.;

wherein the fifth temperature of the fifth zone is between 230-250° F.;

wherein the fifth temperature of the fifth zone is about 240° F.;

wherein the granola mixture is baked in the first zone for a first baking time between 3-10 minutes;

wherein the first baking time is between 4-6 minutes;

wherein the first baking time is about 5 minutes;

wherein the granola mixture is baked in the second zone for a second baking time between 3-10 minutes;

wherein the second baking time is between 4-6 minutes;

wherein the second baking time is about 5 minutes;

wherein the granola mixture is baked in the third zone for a third baking time between 3-10 minutes;

wherein the third baking time is between 4-6 minutes;

wherein the third baking time is about 5 minutes;

wherein the granola mixture is baked in the fourth zone for a fourth baking time between 3-10 minutes;

wherein the fourth baking time is between 4-6 minutes;

wherein the fourth baking time is about 5 minutes;

wherein the granola mixture is baked in the fifth zone for a fifth baking time between 3-10 minutes;

wherein the fifth baking time is between 4-6 minutes;

wherein the fifth baking time is about 5 minutes;

wherein the target RAG: SAG ratio is less than 5.2;

wherein the target RAG:SAG ratio is between 3.56-5.2;

wherein the RAG:SAG ratio is between 3.97-4.79;

wherein the RAG:SAG ratio is about 4.38; and

wherein the method further comprises: breaking the granola-based food product into pieces; sifting the pieces; and forming the pieces into an edible product.

Although embodiments of the invention have been described with reference to several elements, any element described in the embodiments described herein are exemplary and can be omitted, substituted, added, combined, or rearranged as applicable to form new embodiments. A skilled person, upon reading the present specification, would recognize that such additional embodiments are effectively disclosed herein. For example, where this disclosure describes characteristics, structure, size, shape, arrangement, or composition for an element or process for making or using an element or combination of elements, the characteristics, structure, size, shape, arrangement, or composition can also be incorporated into any other element or combination of elements, or process for making or using an element or combination of elements described herein to provide additional embodiments.

Additionally, where an embodiment is described herein as comprising some element or group of elements, additional embodiments can consist essentially of or consist of the element or group of elements. Also, although the open-ended term “comprises” is generally used herein, additional embodiments can be formed by substituting the terms “consisting essentially of” or “consisting of.”

While this invention has been particularly shown and described with reference to preferred embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A granola-based food product having a low RAG: SAG ratio, the granola-based food product comprising:
a binder; and
a dry mix, wherein the dry mix further comprises low-RAG oat flakes;
wherein a RAG: SAG ratio of the granola-based food product is less than or equal to 6.0.

2. The granola-based food product of claim 1, wherein the low-RAG oat flakes comprises a thickness between 0.022-0.016 inches.

3. The granola-based food product of claim 1, wherein the dry mix further comprises wheat flakes.

4. The granola-based food product of claim 3, wherein the wheat flakes comprise a thickness between 0.0390-0.0217 inches.

5. The granola-based food product of claim 3, wherein a ratio of the low-RAG oat flakes to the wheat flakes is between 1:2 to 2:1.

6. The granola-based food product of claim 5, wherein the low-RAG oat flakes and the wheat flakes comprise between 48-80 wt % of the granola-based food product.

7. The granola-based food product of claim 1, wherein the binder comprises between 25-35 wt % of the granola-based food product.

8. The granola-based food product of claim 1, wherein the dry mix comprises between 60-80 wt % of the granola-based food product.

9. The granola-based food product of claim 1, wherein the binder comprises at least one of brown sugar, honey, inulin, water, coconut flavor, canola oil, or combinations thereof.

10. The granola-based food product of claim 3, wherein the dry mix further comprises a premix having at least one of sunflower oil, nonfat dry milk, whey powder, whey protein concentrate, or combinations thereof.

11. A method for forming a granola-based food product having a low RAG: SAG ratio, the method comprising:
combining a dry mix with a binder to form a granola mixture, wherein the dry mix comprises low-RAG oat flakes, and wherein the granola mixture has a moisture content between 7-21 wt %;
cooking the granola mixture in a multi-zone oven, wherein the multi-zone oven provides at least a partially increasing temperature gradient to form the granola-based food product with the low RAG: SAG ratio of less than 6.

12. The method of claim 11, further comprising:
providing low-RAG oat flakes; and
providing wheat flakes.

13. The method of claim 12, wherein the step of providing the low-RAG oat flakes further comprises:
steaming a kilned oat groat ingredient at an oat steaming temperature between 165-195° F. to form steamed oat groats; and
flaking the steamed oat groats to form the low-RAG oat flakes.

14. The method of claim 13, wherein the steamed oat groats is flaked to an average thickness between 0.022-0.016 inches.

15. The method of claim 12, wherein the step of providing the wheat flake further comprises:
steaming a wheat berry ingredient at a wheat steaming temperature between 190-210° F. to form a steamed wheat ingredient; and
flaking the steamed wheat ingredient to form the wheat flakes.

16. The method of claim 15, wherein the steamed wheat ingredient is flaked to an average thickness between 0.0390-0.0217 inches.

17. The method of claim 11, wherein cooking the granola mixture further comprises:
baking the granola mixture in a first zone of the multi-zone oven, wherein the first zone is maintained at a first temperature between 255-265° F.; and
baking the granola mixture in a second zone of the multi-zone oven, wherein the second zone is downstream from the first zone, and wherein the second zone is maintained at a second temperature between 260-270° F. that is higher than the first temperature.

18. The method of claim 17, further comprising:
baking the granola mixture in a third zone of the multi-zone oven, wherein the third zone is downstream from the second zone, and wherein the third zone is maintained at a third temperature that is higher than the second temperature.

19. The method of claim 18, further comprising:
baking the granola mixture in a fourth zone of the multi-zone oven, wherein the fourth zone is downstream from the third zone, and wherein the fourth zone is maintained at a fourth temperature that is lower than the third temperature.

20. The method of claim 19, further comprising:
baking the granola mixture in a fifth zone of the multi-zone oven, wherein the fifth zone is downstream from the fourth zone, and wherein the fifth zone is maintained at a fifth temperature that is lower than the fourth temperature.
